(19) United States
(12) Patent Application Publication
(10) Pub. No.: US 2026/0042425 A1
(43) Pub. Date: Feb. 12, 2026

(54) ASSEMBLY STRUCTURE OF WINDSHIELD WIPER DRIVING ARM

(71) Applicant: DANYANG UPC AUTO PARTS CO., LTD., DANYANG (CN)

(72) Inventors: Che-Wei CHANG, DANYANG (CN); Cheng-Kai YANG, DANYANG (CN); Chuan-Chih CHANG, DANYANG (CN)

(21) Appl. No.: 18/799,981

(22) Filed: Aug. 9, 2024

(51) Int. Cl. B60S 1/40

(52) U.S. Cl. CPC B60S 1/4003

(57) ABSTRACT

An assembly structure of a windshield wiper driving arm, the assembly structure includes an accessory piece and a wiper driving arm. The accessory piece includes a head portion, a main body and a pair of elastic arms. The main body is connected to the head portion. The pair of elastic arms are arranged on two sides of the head portion and two sides of the main body. Each elastic arm includes a pressing section and a positioning section. The positioning section includes a bump. The wiper driving arm includes an arm body and a cover. The cover includes a pair of restricting slots, and the wiper driving arm is coupled to the accessory piece through an engagement of each restricting slot and the bump.

### BACKGROUND OF THE DISCLOSURE

### Technical Field

The technical field relates to a windshield wiper, and more particularly relates to an assembly structure of a windshield wiper driving arm.

### Description of Related Art

A windshield wiper is installed on the exterior surface of the windshield and connected to the driving arm of the car. The driving arm drives the wiper swinging back and forth across the windshield to scrap off rainwater or stains and other foreign objects on the windshield.

Furthermore, the windshield wiper combines the driving arm with the accessory seat, with metal spring plates and a rubber strip mounted on the bottom side of the accessory seat. As a result, the wiper driving arm drives the accessory seat, pressing the metal spring plates and the rubber strip to clean the windshield. Additionally, the wiper driving arm and the accessory seat are assembled through an accessory piece. The combination method between the wiper driving arm and the accessory piece involves a restricting slot on the driving arm and an elastic button on the accessory piece. The elastic button engages with the restricting slot to form the connection. However, since the accessory piece is usually made of plastic parts, the elastic button may age or loose resilience over time and may eventually break away from the restricting slot. As a result, the wiper driving arm may not function properly and may require improvement.

In view of the above drawbacks, the inventor proposes this disclosure based on his expert knowledge and elaborate researches in order to solve the problems of related art

### SUMMARY OF THE INVENTION

This disclosure provides an assembly structure of a windshield wiper driving arm, in which the wiper driving arm is securely coupled with the accessory piece without loosening, thereby providing a stable connection.

This disclosure is an assembly structure of a windshield wiper driving arm, the assembly structure includes an accessory piece and a wiper driving arm. The accessory piece includes a head portion, a main body and a pair of elastic arms. The main body is connected to the head portion. The pair of elastic arms are arranged on two sides of the head portion and two sides of the main body opposite to each other. Each elastic arm includes a pressing section located on the head portion and a positioning section extending to the main body. The positioning section includes a bump located on an end of the elastic arm. The wiper driving arm includes an arm body and a cover connected to the arm body. The cover includes a pair of restricting slots disposed corresponding to the pair of elastic arms, and the wiper driving arm is coupled to the accessory piece through an engagement between the restricting slot and the bump.

In one embodiment of this disclosure, the main body is connected to the head portion, and a stepped portion is defined between the main body and the head portion, the stepped portion comprises a front detent segment and two arc segments connected to the front detent segment, the cover comprises a top surface and two sidewalls connected to the top surface, one side of the top surface abuts against the front detent segment, and the two sidewalls abut against the two arc segments respectively.

In one embodiment of this disclosure, each arc segment comprises a middle arc surface located on each elastic arm, an upper arc surface and a lower arc surface located on two sides of the middle arc surface, the middle arc surface is positioned between the pressing section and the positioning section, an embedding groove is defined between the middle arc surface and the bump, and the side wall of the cover comprises a latch piece located on one side of the restricting slot, and the latch piece is positioned in the embedding groove.

In one embodiment of this disclosure, the main body comprises a supporting rib located on one side of the bump, the cover comprises a resisting piece disposed on the side wall thereof and located on another side of the restricting slot, and the resisting piece abuts against the supporting rib.

In one embodiment of this disclosure, one end of the supporting rib extends toward the head portion and is connected to the lower arc surface.

In one embodiment of this disclosure, the supporting rib extends in a direction parallel to the elastic arm and is configured in an L shape.

In one embodiment of this disclosure, each side wall is bent to form a rail on a side away from the top surface, the main body is inserted between two rails of the two side walls, and each rail abuts against one end of the supporting rib.

In one embodiment of this disclosure, a trench is defined along an outer edge of the elastic arm of the main body.

In one embodiment of this disclosure, a plurality of anti-slip ribs is disposed on a surface of the pressing section.

In one embodiment of this disclosure, the windshield wiper driving arm assembly structure further includes an accessory seat, the accessory seat comprises a pivot, and an axis hole is defined on the main body of the accessory piece, and the accessory seat and the accessory piece are combined through the pivot engaging with the axis hole.

In comparison with the related art, the assembly structure of the windshield wiper driving arm of this disclosure includes an accessory piece with an elastic arm. The elastic arm includes a pressing section and a positioning section, and the positioning section includes a bump. Additionally, the cover of the wiper driving arm features restricting slots corresponding to the elastic arms. The wiper driving arm is combined with the accessory piece through the restricting slot engaging with the bump. This design simplifies the assembly structure of the wiper driving arm, ensures that the wiper driving arm is reliably coupled to the accessory piece without loosening, and achieves a stable connection.

### BRIEF DESCRIPTION OF THE DRAWINGS

FIG. 1 depicts a perspective schematic view of the assembly structure of the windshield wiper driving arm in this disclosure.

FIG. 2 depicts a perspective exploded schematic view of the assembly structure of the windshield wiper driving arm in this disclosure

FIG. 3 depicts a perspective schematic view of the accessory piece in this disclosure.

FIG. 4 depicts a front view of the driving arm combined with the accessory piece in this disclosure.

FIG. 5 depicts a cross-sectional view of line 5-5 in FIG. 4.

FIG. 6 depicts a cross-sectional view of line 6-6 in FIG. 4.

FIG. 7 depicts a cross-sectional view of line 7-7 in FIG. 4.

FIG. 8 depicts a cross-sectional view of line 8-8 in FIG. 4.

### DETAILED DESCRIPTION

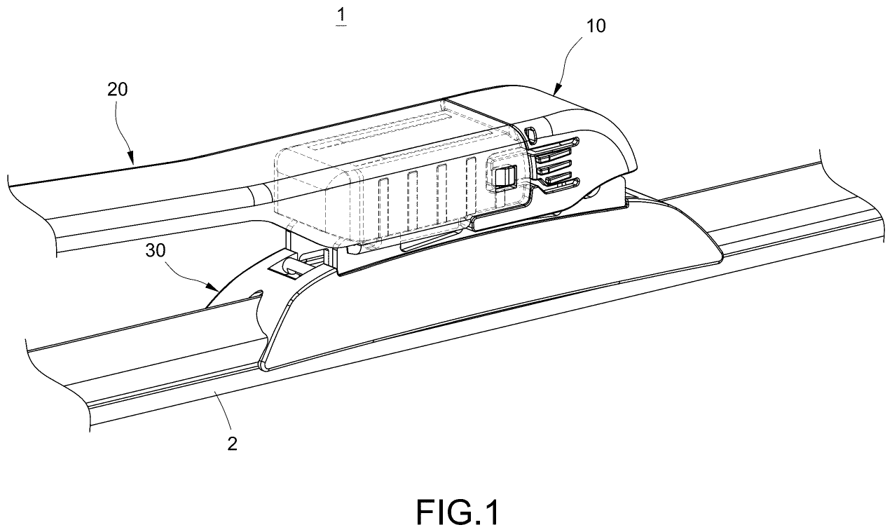

Please refer to FIG. 1, which depicts a perspective schematic view of the assembly structure of the windshield wiper driving arm in this disclosure. The assembly structure 1 of the windshield wiper driving arm of this disclosure includes an accessory piece 10, a wiper driving arm 20, and an accessory seat 30. The wiper driving arm 20 sheathes the accessory piece 10 to be combined with each other. The accessory piece 10 is embedded in the accessory seat 30 to configure the assembly structure 1. It is worth noticing that the accessory seat 30 is further combined with components such as a wiper strip 2 on the bottom thereof to configure a windshield wiper assembly. A more detailed description of the assembly structure 1 is as follows.

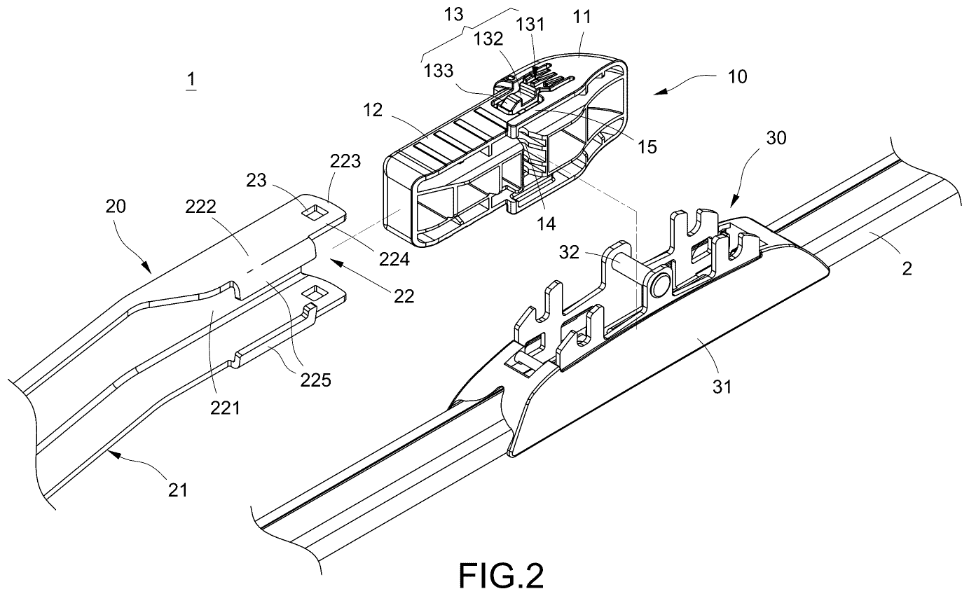

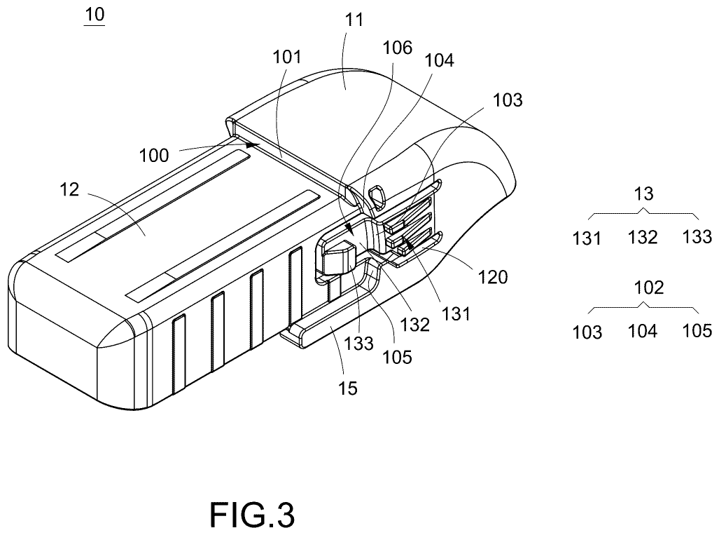

Please refer to FIG. 2 to FIG. 4, which depict a perspective exploded schematic view of the assembly structure, a perspective schematic view of the accessory piece, and a front view of the driving arm combined with the accessory piece in this disclosure. The accessory piece 10 of this disclosure includes a head portion 11, a main body 12, and a pair of elastic arms 13. The main body 12 is connected to the head portion 11. The pair of elastic arms 13 are arranged on two sides of the head portion 11 and two sides of the main body 12 opposite to each other. Additionally, each elastic arm 13 includes a pressing section 131 located on the head portion 11 and a positioning section 132 extending to the main body 12. The positioning section 132 includes a bump 133 located on the end of the elastic arm 13. In this embodiment, a trench 120 is defined along the outer edge of the elastic arm 13. Moreover, a plurality of anti-slip ribs 130 are disposed on the surface of the pressing section 131 to prevent slipping and facilitate the pressing of the pressing section 131, thereby driving the positioning section 132 to deform.

The wiper driving arm 20 includes an arm body 21 and a cover 22 connected to the arm body 21. The cover 22 includes a pair of restricting slots 23 disposed corresponding to the pair of elastic arms 13. The wiper driving arm 20 is coupled to the accessory piece 10 through the engagement of the restricting slot 23 and the bump 133.

Furthermore, the accessory seat 30 includes a base 31 and a pivot 32 arranged on the base 31. An axis hole 14 is defined on the main body 12 of the accessory piece 10. The accessory seat 30 and the accessory piece 10 are combined through the pivot 32 engaging with the axis hole 14. As a result, the wiper driving arm 20 is fixed to the accessory seat 30 through the accessory piece 10.

Specifically, the main body 12 is connected to the head portion 11, and a stepped portion 100 is located between the main body 12 and the head portion 11. The stepped portion 100 includes a front detent segment 191 and two arc segments 102 connected to the front detent segment 101. Additionally, each arc segment 102 includes a middle arc surface 103 disposed on each elastic arm 13, an upper arc surface 104 and a lower arc surface 105 located on two sides of the middle arc surface 103. The middle arc surface 103 is positioned between the pressing section 131 and the positioning section 132. An embedding groove 106 is defined between the middle arc surface 103 and the bump 133. It should be noted that the disposition of the embedded groove 106 may increase the elastic force of the positioning section 132 and also increase the displacement of the bump 133 located on the end of the elastic arm 13.

In this embodiment, the cover 22 includes a top surface 221 and two sidewalls 222 connected to the top surface 221. One side of the top surface 221 abuts against the front detent segment 101, and the two sidewalls 222 abut against the two arc segments 102 respectively. Furthermore, the side wall 222 includes a latch piece 223 located on one side of the restricting slot 23, and the latch piece 223 is located in the embedding groove 106.

In one embodiment of this disclosure, the main body 12 includes a supporting rib 15 located on one side of each bump 133. On the other hand, the side wall 222 of the cover 22 includes a resisting piece 224 located on the other side of the restricting slot 23. The resisting piece 224 abuts against the supporting rib 15. One end of the supporting rib 15 extends toward the head portion 11 and is connected to the lower arc surface 105. Additionally, the supporting rib 15 extends in a direction parallel to the elastic arm 13 and is configured in an L shape.

In more detail, each side wall 222 is bent to form a rail 225 on the side away from the top surface 221. The main body 12 is inserted between two rails 225, and each rail 225 abuts against one end of the supporting rib 15. It should be noted that the arrangement of the supporting rib 15 is used to support the resisting piece 224 and prevents the resisting piece 224 from deforming due to excessive pressure when the driving arm 20 is actuated, and which may otherwise cause the protrusion 133 to be disengaged from the restricting slot 23.

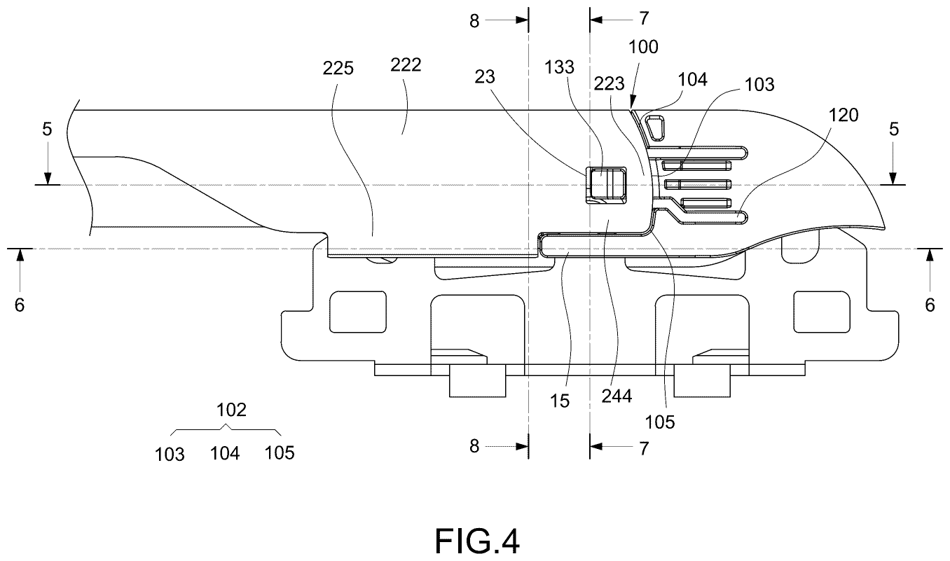

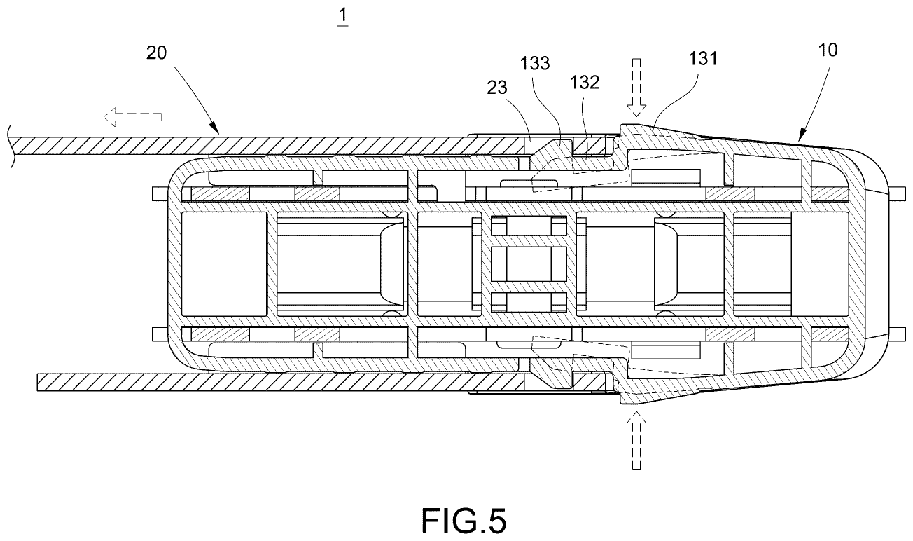

Please refer to FIG. 5 to FIG. 8, which depict cross sectional views of line 5-5, 6-6, 7-7 and 8-8 in FIG. 4, respectively. As shown in FIG. 5, the wiper driving arm 20 in this disclosure is coupled to the accessory piece 10 through the engagement of each restricting slot 23 with the bump 133. Similarly, the accessory piece 10 is released from the engagement of the restricting slot 23 through pressing the pressing section 131, which drives the positioning section 132 to deform. Accordingly, the wiper driving arm 20 may be detached from the accessory piece 10.

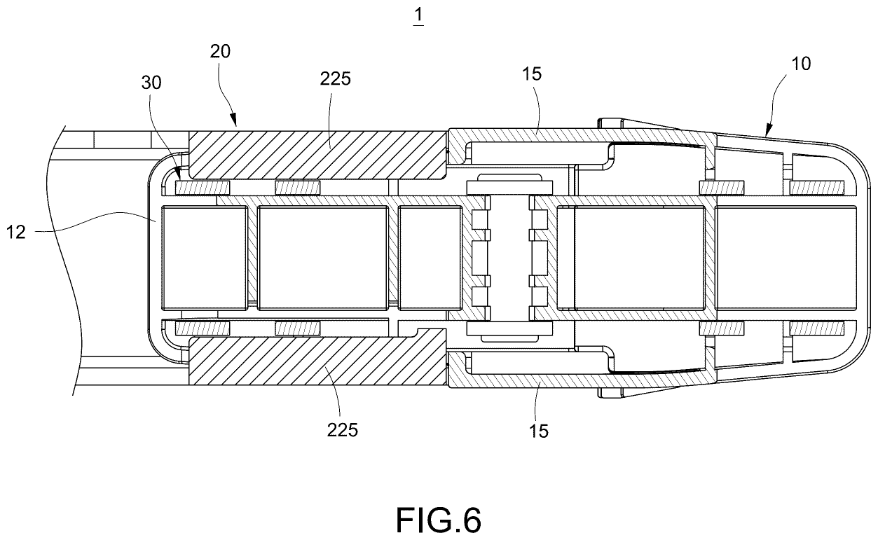

Please further refer to FIG. 6. The wiper driving arm 20 of this disclosure is bent to form a rail 225 located on the bottom of the side wall 222. Additionally, the main body 12 of the accessory piece 10 includes a pair of supporting ribs 15, and each rail 225 abuts against one end of the supporting rib 15.

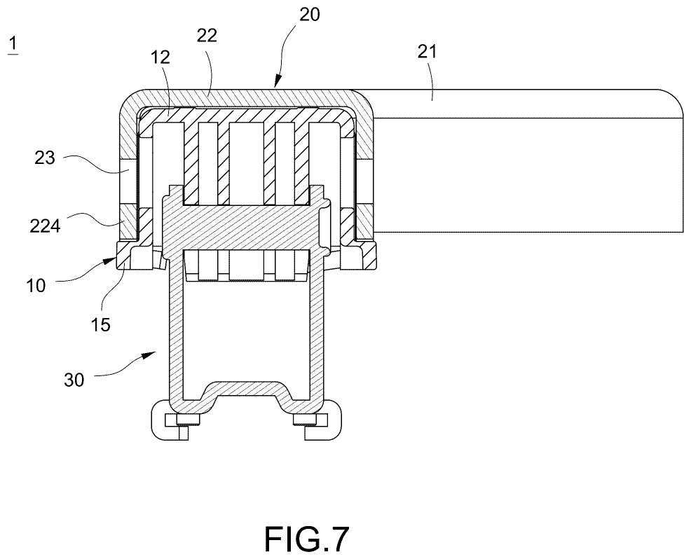

As shown in FIG. 7, the cover 22 of the wiper driving arm 20 in this disclosure includes a resisting piece 224 located on one side of the restricting slot 23 of the side wall 222. When the wiper driving arm 20 is coupled to the accessory piece 10, the resisting piece 224 abuts against the supporting rib 15.

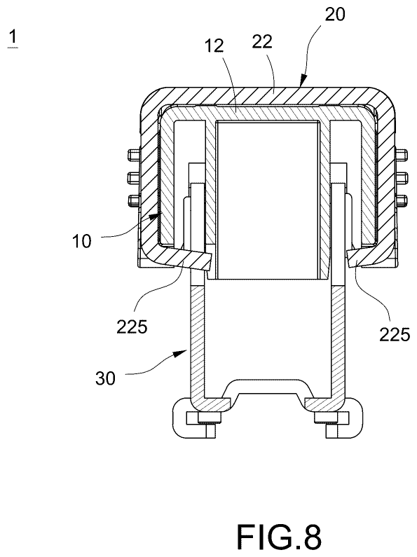

Please further refer to FIG. 8. The wiper driving arm 20 of this disclosure is bent to form a rail 225 on the bottom of the side wall 222. When the wiper driving arm 20 is coupled to the accessory piece 10, the cover 22 of the wiper driving arm 20 sheathes the accessory piece 10. Then, the main body 12 of the accessory piece 10 is inserted between the trails 225 of the cover 22.

While this disclosure has been described by means of specific embodiments, numerous modifications and variations may be made thereto by those skilled in the art without departing from the scope and spirit of this disclosure set forth in the claims.

What is claimed is:

1. An assembly structure of a windshield wiper driving arm, the assembly structure comprising:
an accessory piece, comprising a head portion, a main body, and a pair of elastic arms, wherein the main body is connected to the head portion, the pair of elastic arms are arranged on two sides of the head portion and two sides of the main body opposite to each other, each elastic arm comprises a pressing section located on the head portion and a positioning section extending to the main body, and the positioning section comprises a bump located on an end of the elastic arm; and;
a wiper driving arm, comprising an arm body and a cover connected to the arm body, wherein the cover comprises a pair of restricting slots disposed corresponding to the pair of elastic arms, and the wiper driving arm is coupled to the accessory piece through an engagement between the restricting slot and the bump.

2. The assembly structure according to claim 1, wherein the main body is connected to the head portion, and a stepped portion is located between the main body and the head portion, the stepped portion comprises a front detent segment and two arc segments connected to the front detent segment, the cover comprises a top surface and two sidewalls connected to the top surface, one side of the top surface abuts against the front detent segment, and the two sidewalls abut against the two arc segments respectively.

3. The assembly structure according to claim 2, wherein each arc segment comprises a middle arc surface disposed on each elastic arm, an upper arc surface and a lower arc surface located on two sides of the middle arc surface, the middle arc surface is positioned between the pressing section and the positioning section, an embedding groove is defined between the middle arc surface and the bump, and the cover comprises a latch piece disposed on the side wall thereof and located on one side of the restricting slot, and the latch piece is positioned in the embedding groove.

4. The assembly structure according to claim 3, wherein the main body comprises a supporting rib located on one side of the bump, the cover comprises a resisting piece disposed on the side wall thereof and located on another side of the restricting slot, and the resisting piece abuts against the supporting rib.

5. The assembly structure according to claim 4, wherein one end of the supporting rib extends toward the head portion and is connected to the lower arc surface.

6. The assembly structure according to claim 4, wherein the supporting rib extends in a direction parallel to the elastic arm and is configured in an L shape.

7. The assembly structure according to claim 4, wherein each side wall is bent to form a rail on a side away from the top surface, the main body is inserted between two rails of the two side walls, and each rail abuts against one end of the supporting rib.

8. The assembly structure according to claim 1, wherein a trench is defined along an outer edge of the elastic arm of the main body.

9. The assembly structure according to claim 1, wherein a plurality of anti-slip ribs is disposed on a surface of the pressing section.

10. The assembly structure according to claim 1, further comprising an accessory seat, wherein the accessory seat comprises a pivot, and an axis hole is defined on the main body of the accessory piece, and the accessory seat and the accessory piece are combined through the pivot engaging with the axis hole.
